(19) United States
(12) Patent Application Publication
(10) Pub. No.: US 2015/0335025 A1
(43) Pub. Date: Nov. 26, 2015

(54) CHEMICAL INACTIVATION OF BACILLUS ANTHRACIS SPORES IN SOIL

(71) Applicants: U.S. Environmental Protection Agency, Washington, DC (US); Battelle Memorial Institute, Columbus, OH (US)

(72) Inventors: Joseph P. WOOD, Cary, NC (US); Morgan Q.S. WENDLING, Worthington, OH (US); Andrew LASTIVKA, Columbus, OH (US)

(73) Assignees: U.S. Environmental Protection Agency, Washington, DC (US); Battelle Memorial Institute, Columbus, OH (US)

(21) Appl. No.: 14/282,981

(22) Filed: May 20, 2014

(51) Int. Cl. A01N 59/02

(52) U.S. Cl. CPC A01N 59/02

(57) ABSTRACT

A method for the inactivation of B. anthracis spores in soil comprising contacting the soil with an effective amount of a persulfate and an activator for a time sufficient to inactivate substantially all of the B. anthracis spores contained therein.

### BACKGROUND OF THE INVENTION

1. Field of the Invention

The invention relates to the field of soil decontamination.

2. Description of the Related Art

There is a long standing need for effective means for protecting human health and the environment from adverse impacts resulting from the release of chemical, biological, or radiological agents. Residual biological agent (such as B. anthracis, the causative agent for anthrax) in soil after, for example, an intentional release by a bioterrorist, presents a potential health risk, even after following conventional decontamination procedures. To date, no effective method for inactivating B. anthracis in soil has appeared in the art. It is an object of the present invention to provide such a method.

### SUMMARY OF THE INVENTION

An embodiment of the invention provides a method for the inactivation of B. anthracis spores in soil contaminated therewith comprising contacting the soil with an effective amount of a persulfate and an activator (e.g., hydrogen peroxide, ferrous ions) for a time sufficient to inactivate substantially all of the B. anthracis spores contained therein.

Additional aspects and/or advantages of the invention will be set forth in part in the description which follows and, in part, will be obvious from the description, or may be learned by practice of the invention.

### DETAILED DESCRIPTION OF THE EMBODIMENTS

Reference will now be made in detail to the present embodiments of the present invention.

The present invention is predicated on the unexpected discovery that a persulfate and an activator effectively inactivates substantially all of the B. anthracis spores in a soil contaminated therewith, provided that contact between the contaminated soil and an effective amount of the composition is maintained for a sufficiently long period of time.

The persulfate and activator may be applied to the soil simultaneously or sequentially. When applied sequentially, either the persulfate or hydrogen peroxide may be applied first followed by the other.

Although it is known that a composition comprising a persulfate and hydrogen peroxide is effective for oxidizing volatile organic compounds contained in soil (U.S. Pat. No. 7,524,141), the fact that such a composition would also be effective for inactivating B. anthracis spores in a soil contaminated therewith was totally unexpected.

It is demonstrated below that persulfates are efficacious for the inactivation of B. anthracis spores in soils as varied as topsoil and Arizona Test Dust (AZDT). Decontamination efficacy was determined based on the log reduction (LR) in viable spores recovered from the inoculated samples, with and without exposure to the decontaminant. For the sodium persulfate tests, a contact time of seven days was used for each test (Table 1). For each test listed below, separate subtests were conducted for each combination of microorganism and soil type.

TABLE 1
Sodium Persulfate Klozur ™ Test Matrix

| | | | Application Frequency* | Contact |
|---|---|---|---|---|
| | Biological | | (total number of | Time |
| Test # | Agent | Soil Type | applications) | (days) |
| 1 | B. anthracis | Topsoil | Every 60 minutes (6) | 7 |
| | B. subtilis | AZTD | | |
| 2 | B. anthracis | Topsoil | Every 60 minutes (3) | 7 |
| | B. subtilis | AZTD | | |
| 3 | B. anthracis | Topsoil | Days 0, 2 and 4 (3) | 7 |
| | B. subtilis | AZTD | | |
| 4 | B. anthracis | Topsoil | Time 0 and 1 Hr (2) | 7 |
| | B. subtilis | AZTD | | |
| 5 | B. anthracis | Topsoil | Day 0 (1) | 7 |
| | B. subtilis | AZTD | | |

*= Each application consisted of 1 mL Klozur ™ followed by 1 mL 8% H₂O₂.

The B. anthracis spores used for this testing were prepared from a qualified stock of the Ames strain at the Battelle Biomedical Research Center (BBRC, West Jefferson, Ohio). All spore lots were subject to a stringent characterization and qualification process. Specifically, all spore lots were characterized prior to use by observation of colony morphology, direct microscopic observation of spore morphology and size and determination of percent refractivity and percent encapsulation (of the vegetative bacterial colonies). In addition, the number of viable spores was determined by colony count and expressed as colony forming units per milliliter (CFU/mL). Theoretically, once plated onto bacterial growth media, each viable spore germinates and yields one CFU. Variations in the expected colony phenotypes were recorded.

To ensure spores are used in testing (and not vegetative cells), various steps are taken, described as follows. The spore stock is stored in purified water and characterized via visual purity. The stock is viewed under the microscope, viable spores are then counted and any cell debris is noted. The spore preparation must have a minimum 95% purity vs. debris and non-viable spores. The spore prep is also heat shocked prior to removing from the fermenter. In addition, testing was conducted for robustness of the spores via hydrochloric acid (HCl) resistance.

The B. subtilis spores (BBRC stock culture; American Type Culture Collection [ATCC] 19659) underwent the same characterization tests as described above for B. anthracis, except that the LAL assay, DNA fingerprinting, and virulence testing were excluded. Qualitative PCR was performed using a custom PCR assay to confirm B. subtilis. Primers were designed that targeted a conserved region of B. subtilis chromosomal DNA because multiple strains of this bacterium exist.

The stock spore suspensions were prepared in SFW at an approximate concentration of 1×1 CFU/mL and stored under refrigeration at 2 to 8 degrees Celsius (° C.).

Information on the soil types used for testing is presented in Table 2. Soil samples were placed unpacked in one ounce (oz), 1.5 inch diameter glass jars (Qorpak®, #GLC-O 1596, Bridgeville, Pa.) at a depth of one cm for testing. The commercial topsoil used for this evaluation was a proprietary mixture of soil, composted cow manure, sand, and other ingredients (also proprietary). Topsoil was selected for testing since it represents a difficult soil to treat in terms of its organic content. The AZTD was selected for testing since it represents a soil with minimal organic burden.

Soils used in the tests were prepared for testing by sterilization via gamma irradiation at 40 kilogray (kGy; STERIS Isomedix Services, Libertyville, Ill.). Soils were pre-sterilized to minimize contamination that could interfere with colony counting. In addition to gamma irradiation at ˜40 kGy, samples were gamma irradiated at ˜60 kGy or autoclaved at 121° C. for one hr. Gamma-irradiated soils were sealed in Lock & Lock containers (Farmers Branch, Tex.) and autoclaved soils were sealed in sterilization pouches (Cat # 01-812-51, Fisher Scientific, Pittsburgh, Pa.) to preserve sterility until the samples were ready for use.

TABLE 2
Soil Materials

| | | | Pre- | Pre- |
|---|---|---|---|---|
| | | | sterilized | sterilized |
| | Lot, Batch, or | | moisture | organic car- |
| | ASTM No., or | Manufacturer/ | content | bon content |
| Material* | Observation | Supplier Name | (%) | (%) |
| Topsoil | Earthgro ® | The Scotts | 34 | 9.3 |
| | Topsoil, | Company | | |
| | Product #: | Marysville, OH | | |
| | 71140180 | | | |
| Arizona | ISO 12103-1, | Powder | 0.23 | 0.40 |
| Test Dust | A3 | Technology, Inc. | | |
| | Medium | Burnsville, MN | | |

*A soil sample consisted of a 1.5 in diameter glass jar filled with uncompacted soil to a height of 1 cm.

Prior to decontamination testing, samples (pre- and post-sterilization) were analyzed in triplicate using ASTM D Method 2974-8 7 for Moisture, Ash and Organic Matter of Peat and Other Organic Soils. The topsoil had a much higher moisture and organic content compared to the AZTD. The moisture and organic content did not change significantly after the gamma irradiation of the samples. However, slight changes were observed in autoclaved samples.

Test and positive control soil samples (in their jars) were placed on a flat surface within a Class II biological safety cabinet (BSC) and inoculated with approximately 1×10⁸ CFU of viable B. anthracis spores per sample. A 100 microliter aliquot of a stock suspension of approximately 1×10⁹ CFU/mL was dispensed using a micropipette applied as 10 μL droplets across the soil surface. This approach provided a more uniform distribution of spores across the sample surface than would be obtained through a single drop of the suspension. After inoculation, the samples were left undisturbed overnight in a Class III BSC to dry under ambient conditions, approximately 22° C. and 40% relative humidity (RH). A heat shock test was conducted to confirm that no germination of cells occurred (only spores present) while spores were left in soil samples overnight.

The number and type of replicate samples used for each combination of material, decontaminant, concentration, and environmental condition included were:
five test samples (inoculated with B. anthracis spores and exposed to decontaminant)
five positive controls (inoculated with B. anthracis spores but not exposed to decontaminant)
one laboratory blank (inoculated with sterile water only and not exposed to the decontaminant)
one procedural blank (inoculated with sterile water only and exposed to the decontaminant).

On the day following spore inoculation, the jars of soil samples intended for decontamination (including blanks) were transferred into a test chamber where the decontamination technology was applied using the apparatus and application conditions specified below.

At the appropriate decontaminant contact time, spores were extracted from the soil samples by adding 10 mL of sterile phosphate-buffered saline extraction buffer containing 0.1% Triton® X-100 surfactant (PBST; Sigma, St. Louis, Mo.) and neutralizer (to stop sporicidal activity when liquid decontaminant was used to each sample jar. The jars were capped and agitated on an orbital shaker for 15 minutes at approximately 200 revolutions per minute (rpm) at room temperature.

Residual viable spores were quantified using a dilution plating approach. Following extraction, the extract was removed and a series of 10-fold dilutions was prepared in sterile water. An aliquot (0.1 mL) of either the undiluted extract and/or each serial dilution was plated onto tryptic soy agar in triplicate and incubated for 18-24 hours (hr) at 35-37° C. Colonies were counted manually and CFU/mL was determined by multiplying the average number of colonies per plate by the reciprocal of the dilution. Dilution data representing the greatest number of individually definable colonies were expressed as arithmetic mean±standard deviation of the numbers of CFU observed.

Laboratory blanks controlled for sterility and procedural blanks controlled for viable spores inadvertently introduced to test samples. The blanks were inoculated with an equivalent amount of 0.1 mL SFW. The target acceptance criterion was that extracts of laboratory or procedural blanks were to contain zero CFU of target organism.

After each decontamination test, the BSC Ill was cleaned thoroughly (using separate steps involving bleach, ethanol, water, then drying) following procedures established under the BBRC Facility Safety Plan.

The mean percent spore recovery from each soil sample was calculated using results from positive control samples (inoculated, not decontaminated), by means of the following equation:

Mean % Recovery=[Mean CFU_{pc}/CFUₛₚᵢₖₑ]×100 (1)

where Mean CFU_{pc} is the mean number of CFU recovered from five replicate positive control samples of a single material, and CFUₛₚᵢₖₑ is the number of CFU inoculated onto each of those samples. The value of CFUₛₚᵢₖₑ is known from enumeration of the stock spore suspension. Spore recovery was calculated for B. anthracis or B. subtilis on each soil sample, and the results set forth below.

The performance or efficacy of the decontaminants was assessed by determining the number of viable organisms remaining on each soil test sample after decontamination. Those numbers were compared to the number of viable organisms extracted from the positive control samples.

The number of viable spores of B. anthracis in extracts of test and positive control samples was determined to calculate efficacy of the decontaminant. Efficacy is defined as the extent (as log₁₀ reduction) to which viable spores extracted from test samples after decontamination were less numerous than the viable spores extracted from positive control samples. The logarithm of the CFU abundance from each sample extract was determined, and the mean of those logarithm values was then determined for each set of control and associated test samples, respectively. Efficacy of a decontaminant for a test organism/test condition on the i^{th} sample material was calculated as the difference between those mean log values, i.e.:

$$\text{?}$$

$$Efficacy = ( {log}_{10} {CFUc}_{ij} ) - ( {log}_{10} {CFUt}_{ij} ) \\ \text{?} \text{indicates text missing or illegible when filed} \qquad \vert ( 2 ) \vert [ WJ 1 ]$$

where log₁₀ CFUcᵢⱼ refers to the j individual logarithm values obtained from the positive control samples, and log₁₀ CFUtᵢⱼ refers to the j individual logarithm values obtained from the corresponding test samples, and the overbar designates a mean value. In tests conducted under this plan, there were five positive controls and five corresponding test samples (i.e., j=5) for each soil sample. A decontaminant that achieves a 6 LR or greater is considered effective.

In the case where no viable spores were detected in any of the five test sample extracts after decontamination, a CFU abundance of 1 was assigned, resulting in a log₁₀ CFU of zero for that material. When this occurs, the spore population on the soil sample is considered to be completely inactivated within the detection limit of 33 CFU per soil sample. With complete spore inactivation, the decontaminant achieves the maximum efficacy possible or quantifiable. That is, the final efficacy on that material is reported as greater than or equal to (≧) the value calculated by Equation 2. With complete inactivation, the reported LR value is dependent on the positive control recovery, and in most cases, the LR≧7.5.

The variances (i.e., the square of the standard deviation) of the log₁₀ CFUcᵢⱼ and log₁₀ CFUtᵢⱼ values were also calculated for both the control and test samples (i.e., S²cᵢⱼ and S²tᵢⱼ), and were used to calculate the pooled standard error (SE) for the efficacy value calculated in Equation 2, as follows:

$$S E = \sqrt{\frac{{S}^{2} {c}_{ij}}{5} + \frac{{S}^{2} {t}_{ij}}{5}} \qquad ( 3 )$$

where the number 5 again represents the number j of samples in both the control and test data sets. Each efficacy result is reported as an LR value with an associated 95% confidence interval (CI), calculated as follows:

95% CI=Efficacy±(1.96×SE) (4)

The significance of differences in efficacy across different test conditions and spore types was assessed based on the 95% confidence interval of each efficacy result. Differences in efficacy were judged to be significant if the 95% CIs of the two efficacy results did not overlap. Any results based on this formula are hereafter noted as significantly different. Note this comparison is not applicable when the two efficacy results being compared are both reported with LRs as≧some value.

The physical effect of the decontaminants on the soil materials was also monitored qualitatively during the evaluation. This approach provided a gross visual assessment of whether the decontaminants altered the appearance of the soil, e.g., discoloration. The procedural control (sample that is decontaminated, but has no spores applied) was visually compared to a laboratory blank sample (a sample not exposed to the decontaminant and that has no spores applied).

### Decontamination Procedures

Sodium Persulfate Klozur™

Klozur™ was used as the source of sodium persulfate and is a solid reagent made by FMC Corporation used for in situ and ex situ chemical oxidation of contaminants in environmental remediation applications e.g., soil. Klozur™ consists >99% pure sodium persulfate (Na₂S₂O₈) in the form of white odorless crystals. In remediation applications. Klozur™ is injected into contaminated soil or groundwater and activated by mixing in appropriate proportions of up to 8% H₂O₂ by weight. Activation of Klozur™ with H₂O₂ generates sulfate radicals (SO₄*) which are capable of destroying a wide range of organic contaminants while maintaining oxidative ability in a soil (organic) environment. For testing, a 0.5 M solution of sodium persulfate was prepared by dissolving 12 g of Klozur™ in SFW and diluting to 100 μL. This solution was 11.9% persulfate by weight. Commercially prepared 8% H₂O₂ solution was purchased for use in testing.

It will be understood by those skilled in the art that any suitable persulfate may be employed; e.g., ammonium, potassium, or sodium persulfate.

All liquid decontaminant tests were conducted at ambient conditions inside a climate-controlled laboratory. The temperature inside the testing chamber was equilibrated to the ambient laboratory temperature of approximately 20° C. The temperature and RH were both monitored and recorded with a HOBO® data logger (Onset Computer Corporation, Cape Cod, Mass.), but no attempt was made to control either. All experiments took place in a Class III BSC.

Sodium thiosulfate (STS) was used to neutralize Klozur™/H₂O₂ decontaminant after the desired contact times were achieved. The optimum concentration of STS in the extraction buffer was determined in trial runs for each application regimen (number of applications of the decontaminant and contact time) that was tested. In each of those trials, a range of STS concentrations was assessed to determine the STS concentration that most effectively stopped the action of the decontaminant (indicated by the maximum recovery of viable spores in the sample extracts).

Sodium Persulfate Decontamination Procedure

For the Klozur™ tests, a 1 mL volume of the 0.5 M persulfate solution was added to each sample jar and mixed with a glass stirring rod. A 1 mL volume of the 8% H₂O₂ activating solution was immediately applied and mixed in the same manner. SFW was applied to the control samples at all application times in the same manner. This process was repeated for multiple applications as shown above. After the last application, all samples were left uncapped in the Class III BSC until the end of the specified contact time (all tests used a seven-day contact time). At the end of the contact time, all samples were dry, and extracted as described above. Equal volumes of the persulfate and H₂O₂ solutions resulted in a H₂O₂/persulfate molar ratio of 5 to 1, a typical ratio recommended for the use of Klozur™ in soil remediation. It will be understood by those skilled in the art that the molar ratio of persulfate to hydrogen peroxide may range from 1:20 to 20:1.

A contact time of one week was selected, based on information indicating this oxidant can persist in subsurface environments for hours to weeks.

Quality assurance/quality control (QC) procedures were performed in accordance with the Quality Management Plan (QMP) and the test/QA Plan. The QA/QC procedures and results are summarized below. All equipment (e.g., pipettes. incubators, biological safety cabinets) and monitoring devices (e.g., thermometer, hygrometer) used at the time of evaluation were verified as being certified, calibrated, or validated. Quality control efforts conducted during decontaminant testing included positive control samples (inoculated, not decontaminated), procedural blanks (not inoculated, decontaminated), laboratory blank (not inoculated, not decontaminated), and inoculation control samples (analysis of the stock spore suspension). All positive control results were within the target recovery range of 1 to 150% of the inoculated spores, and all procedural and laboratory blanks met the criterion of no observed CFU for both organisms. Inoculation control samples were taken from the spore suspension on the day of testing and serially diluted, nutrient plated, and counted to establish the spore density used to inoculate the samples. The spore density levels met the QA target criterion of 1×10⁹ CFU/mL (±1 log) for all tests. Performance evaluation audits were conducted to assess the quality of the results obtained during these experiments. Table 3 summarizes the performance evaluation audits that were performed. No performance evaluation audits were performed to confirm the concentration of B. anthracis spores. Unlike chemical analytes, commercially available quantitative standards do not exist for this organism. The control samples and blanks support the spore measurements.

TABLE 3
Performance Evaluation Audits

| | Audit | Allowable | | Actual | |
|---|---|---|---|---|---|
| Measurement | Procedure | Tolerance | | Tolerance | |
| Volume of liquid from | Gravimetric evaluation | ±10% | | ±0.57% | |
| micropipettes | | | | | |
| Time | Compared to independent clock | ±2 | sec/hr | 0 | sec/hr |
| Temperature | Compared to independent calibrated | ±2° | C. | ±0.36° | C. |
| | thermometer | | | | |
| Relative Humidity | Compare to independent calibrated | ±10% | | ±2% | |
| | hygrometer | | | | |
| Fumiscope ™ thermal | Instrument was certified as calibrated at | ±10% | | 0% | |
| conductivity meter | the time of use | | | | |
| Balance | Compared to independent calibrated | ±0.5 | g | ±0.03 | g |
| | weight sets | | | | |

### Results and Performance Summary for Sodium Persulfate

The quantitative efficacy results the Klozur™ are presented in detail in Tables 4 and 5. All tests were conducted with a contact time of seven days, with the number of applications of the sodium persulfate H₂O₂ decontaminant ranging from 1 to 6. The most robust treatment. the six application regimen (Test 1) resulted in complete inactivation of B. anthracis on both soil materials. The next robust treatment (three applications of the decontaminant all applied within the first 2 hours; Test 2) provided greater than a 7 LR for B. anthracis on both soils. Efficacy generally decreased with decreasing number of persulfate applications: none of the other sodium persulfate application conditions resulted in greater than a 6 LR.

When comparing the results for the topsoil and AZTD, the decontamination effectiveness of the sodium persulfate against B. anthracis was not significantly different for the two soil types for the majority of tests. These results generally indicate that the organic content of the topsoil did not diminish efficacy, which is consistent with its persistent oxidative ability and commercial use as a soil remediation technology.

Two tests were conducted to assess whether the frequency of the application of sodium persulfate affected decontamination efficacy. In these two tests, we used a contact time of seven days and three applications of the sodium persulfate, but in one test it was applied once every hour (Test 2), and in the other, it was applied every 48 hours (Test 3). When applied every hour. the efficacy was significantly greater than when it was applied every 48 hours (on Days 0, 2 and 4) against B. anthracis: 7.07 VS. 5.53 LR on topsoil and 7.38 vs 5.24 LR on AZTD).

TABLE 4
Inactivation of Bacillus anthracis Spores on Topsoil with Klozur ™^{, a}

| Contact Time | | | | |
|---|---|---|---|---|
| (Number of Applications) | | Mean of Logs of | Mean % | Decontamination |
| Test # | Inoculum (CFU) | Observed CFU | Recovery | Efficacy ± CI^{f} |
| Seven Days (6)^{†} - #1 | | | | |
| Positive Controls^{b} | 8.97 × 10⁷ | 7.82 ± 0.04 | 74.35 ± 7.50 | —^{g} |
| Test Samples^{c} | 8.97 × 10⁷ | 0 | 0 | ≧7.82 ± 0.04 |
| Laboratory Blank^{d} | 0 | 0 | — | — |
| Procedural Blank^{e} | 0 | 0 | — | — |
| Seven Days (3)^{†} - #2 | | | | |
| Positive Controls | 8.97 × 10⁷ | 7.72 ± 0.04 | 58.51 ± 5.65 | — |
| Test Samples | 8.97 × 10⁷ | 0.65 ± 1.46 | 0.00041 ± 0.00090 | 7.07 ± 1.28 |
| Laboratory Blank | 0 | 0 | — | — |
| Procedural Blank | 0 | 0 | — | — |
| Seven Days (3)^{‡} - #3 | | | | |
| Positive Controls | 1.12 × 10⁸ | 7.62 ± 0.09 | 37.98 ± 8.74 | — |
| Test Samples | 1.12 × 10⁸ | 2.09 ± 1.40 | 0.00093 ± 0.0014 | 5.53 ± 1.23 |
| Laboratory Blank | 0 | 0 | — | — |
| Procedural Blank | 0 | 0 | — | — |
| Seven Days (2)^{†} - #4 | | | | |
| Positive Controls | 1.23 × 10⁸ | 7.83 ± 0.08 | 55.45 ± 9.91 | — |
| Test Samples | 1.23 × 10⁸ | 4.03 ± 1.13 | 0.00089 ± 0.0017 | 3.80 ± 1.00 |
| Laboratory Blank | 0 | 0 | — | — |
| Procedural Blank | 0 | 0 | — | — |
| Seven Days (1) - #5 | | | | |
| Positive Controls | 8.83 × 10⁷ | 7.68 ± 0.08 | 54.90 ± 10.81 | — |
| Test Samples | 8.83 × 10⁷ | 6.75 ± 0.31 | 0.076 ± 0.042 | 0.93 ± 0.28 |
| Laboratory Blank | 0 | 0 | — | — |
| Procedural Blank | 0 | 0 | — | — |

^{a} Data are expressed as the mean (±SD) of the logs of the number of spores (CFU) observed on five individual samples, the mean percent recovery on those five samples, and decontamination efficacy (log reduction).
^{b}Positive Controls = samples inoculated, not decontaminated.
^{c}Test Samples = samples inoculated, decontaminated.
^{d}Laboratory Blank = samples not inculated, not decontaminated.
^{e}Procedural Blank = samples not inculated, not decontaminated.
^{f}CI = confidence interval (±1.96 × SE).
^{g}“—” Not Applicable.
^{†}The decontaminant was applied every 60 minutes until the total number of applications was reached.
^{‡}The decontaminant was applied on days 0, 2 and 4.

TABLE 5
Inactivation of Bacillus anthracis Spores on AZDT with Klozur ™^{, a}

| Contact Time | | | | |
|---|---|---|---|---|
| (Number of Applications) | | Mean of Logs of | Mean % | Decontamination |
| Test # | Inoculum (CFU) | Observed CFU | Recovery | Efficacy ± CI^{f} |
| Seven Days (6)^{†} - #1 | | | | |
| Positive Controls^{b} | 8.97 × 10⁷ | 7.87 ± 0.10 | 83.94 ± 19.52 | —^{g} |
| Test Samples^{c} | 8.97 × 10⁷ | 0 | 0 | ≧7.87 ± 0.09 |
| Laboratory Blank^{d} | 0 | 0 | — | — |
| Procedural Blank^{e} | 0 | 0 | — | — |
| Seven Days (3)^{†} - #2 | | | | |
| Positive Controls | 8.97 × 10⁷ | 7.69 ± 0.04 | 55.21 ± 5.04 | — |
| Test Samples | 8.97 × 10⁷ | 0.31 ± 0.70 | 0.0000091 ± 0.000018 | 7.38 ± 0.61 |
| Laboratory Blank | 0 | 0 | — | — |
| Procedural Blank | 0 | 0 | — | — |
| Seven Days (3)^{‡} - #3 | | | | |
| Positive Controls | 1.12 × 10⁸ | 7.79 ± 0.10 | 56.46 ± 12.98 | — |
| Test Samples | 1.12 × 10⁸ | 2.55 ± 0.59 | 0.00054 ± 0.00051 | 5.24 ± 0.53 |
| Laboratory Blank | 0 | 0 | — | — |
| Procedural Blank | 0 | 0 | — | — |
| Seven Days (2)^{†} - #4 | | | | |
| Positive Controls | 1.23 × 10⁸ | 7.48 ± 0.31 | 30.32 ± 25.09 | — |
| Test Samples | 1.23 × 10⁸ | 3.31 ± 1.33 | 0.025 ± 0.050 | 4.17 ± 1.19 |
| Laboratory Blank | 0 | 0 | — | — |
| Procedural Blank | 0 | 0 | — | — |
| Seven Days (1) - #5 | | | | |
| Positive Controls | 8.83 × 10⁷ | 7.95 ± 0.13 | 104.24 ± 32.81 | — |
| Test Samples | 8.83 × 10⁷ | 3.58 ± 0.26 | 0.0049 ± 0.0026 | 4.37 ± 0.26 |
| Laboratory Blank | 0 | 0 | — | — |
| Procedural Blank | 0 | 0 | — | — |

^{a} Data are expressed as the mean (±SD) of the logs of the number of spores (CFU) observed on five individual samples, the mean percent recovery on those five samples, and decontamination efficacy (log reduction).
^{b}Positive Controls = samples inoculated, not decontaminated.
^{c}Test Samples = samples inoculated, decontaminated.
^{d}Laboratory Blank = samples not inculated, not decontaminated.
^{e}Procedural Blank = samples not inculated, not decontaminated.
^{f}CI = confidence interval (±1.96 × SE).
^{g}“—” Not Applicable.
^{†}The decontaminant was applied every 60 minutes until the total number of applications was reached.
^{‡}The decontaminant was applied on days 0, 2 and 4.

The minimum conditions required to obtain at least a 6 LR for each combination of decontamination technology and soil type is 3 applications every 60 minutes. More stringent conditions, such as higher concentration, more applications, or longer contact time typically resulted in higher efficacy, and in some cases, complete inactivation.

At the end of each decontamination test, the procedural blanks were compared visually to the laboratory blanks, and test samples were compared visually to positive controls, to assess any impact (i.e., discoloration) the decontaminants may have had on each material type. Based on the visual appearance of the decontaminated samples, there were no apparent changes in the color of the two soil types after being exposed to sodium persulfate.

Although a few embodiments of the present invention have been shown and described, it would be appreciated by those skilled in the art that changes may be made in this embodiment without departing from the principles and spirit of the invention, the scope of which is defined in the claims and their equivalents.

1. A method for the inactivation of B. anthracis spores in soil contaminated therewith comprising contacting the soil with an effective amount of a persulfate in solution and an oxidation activator for a time sufficient to inactivate substantially all of the B. anthracis spores contained therein.

2. The method of claim 1 wherein said activator is hydrogen peroxide.

3. The method of claim 1 wherein said persulfate is sodium persulfate.

4. The method of claim 1 wherein said soil is contacted with said persulfate solution and oxidation activator at least 3 times at 60 minute intervals and thereafter the persulfate and oxidation activator are allowed to remain in contact with the substrate contaminated with B anthracus spores for at least 7 days.

5. The method of claim 1 wherein the persulfate solution and the oxidation activator are applied simultaneously.

6. The method of claim 1 wherein the persulfate solution is applied before the oxidation activator.

7. The method of claim 1 wherein the oxidation activator is applied before application of the persulfate solution.
